(19) United States
(12) Patent Application Publication
(10) Pub. No.: US 2013/0031581 A1
(43) Pub. Date: Jan. 31, 2013

(54) PREPARING AN ALERT IN A MULTI-CHANNEL COMMUNICATIONS ENVIRONMENT

(71) Applicants: Nitya Narasimhan, Hopewell Junction, NY (US); Venugopal Vasudevan, Palatine, IL (US); Joseph F. Wodka, Hoffman Estates, IL (US)

(72) Inventors: Nitya Narasimhan, Hopewell Junction, NY (US); Venugopal Vasudevan, Palatine, IL (US); Joseph F. Wodka, Hoffman Estates, IL (US)

(73) Assignee: GENERAL INSTRUMENT CORPORATION, Horsham, PA (US)

(21) Appl. No.: 13/189,689

(22) Filed: Jul. 25, 2011

(51) Int. Cl. H04N 7/10

(52) U.S. Cl. 725/33

(57) ABSTRACT

The pervasive visibility of television and other screens is leveraged to present pop-up alerts to users. These alerts can be made to appear on any channel at any time, but they are formatted in a way that suits the differing policies of the various channel providers. When an alert is received, an “alert mediator” determines which channel is currently being played on a first user device. The alert mediator reviews alert-rendering rules for that particular channel and prepares the alert according to those rendering rules. The alert is then presented either to that first user device or to a second user device. A rule can provide for “skinning” the alert so that the alert fits in with the “look and feel” of the channel. When a user device displays more than one channel at the same time, the alert mediator chooses which channel's rules to apply in displaying the alert.

### FIELD OF THE INVENTION

The present invention is related generally to computer communications and, more particularly, to interactive television.

### BACKGROUND OF THE INVENTION

In addition to supporting traditional “content-consumption” experiences (e.g., broadcast programming), modern television sets (and their associated set-top boxes) are beginning to provide interactive and social experiences. For example, a television screen can show an interactive user interface overlaid onto the television's traditional streaming content, the user interface supporting an application that complements the streaming content (e.g., an interactive sports interface overlaid onto a sports network feed). In another example, the television screen becomes yet another display, in addition to the displays of home computers, smart telephones, and other user devices, for Internet-based user applications. For some of these applications, content is “pulled down” from the Internet for display on the television. In more sophisticated applications, third-party web providers “push” content down to a television that supports a fully bidirectional interaction.

Industry reports show (a) that viewers are spending more time than ever watching television and (b) that the average U.S. home has more televisions than people (2.86 televisions for 2.5 people). These reports lead to the conclusion that the television is one of the most pervasively visible displays in the home, from the user's perspective. That said, industry reports also show that users often “multi-task” while the television is on, that is, they sometimes focus their attention on other displays and not necessarily on the television. Still, the users are at most times at least peripherally aware of the content that the television is displaying.

Many television-content providers classify interactive applications as either “bound” or “unbound.” Bound applications are tightly coupled to a particular television channel (e.g., a news ticker coupled to a news channel or a fantasy football application coupled to a sports channel), and bound applications are authorized by and often provided by the channel provider. A bound application only appears when the user tunes to the associated channel, and the bound application disappears when the user tunes to another channel. In contrast, an unbound application is not associated with any particular television channel and can be accessed regardless of the channel that the user is currently watching. Examples of unbound applications include a television program guide, an on-demand menu, and a user interface for controlling a digital video recorder or a set-top box.

Generally, both bound and unbound interactive applications appear in response to an explicit user request (e.g., via a menu selection from the user's remote control). Both types of applications are inherently “synchronous:” Bound applications are tied to a channel-selection event, and unbound applications are tied to user-input events. Both types of applications are orchestrated: bound applications by the channel provider, and unbound applications by the user or by the television provider.

### BRIEF SUMMARY

The above considerations, and others, are addressed by the present invention, which can be understood by referring to the specification, drawings, and claims. The pervasive visibility of television and other screens is leveraged, according to aspects of the present invention, to present “pop-up” alerts to users. These alerts can be made to appear on any channel at any time (i.e., unboundedly and asynchronously), but they are formatted in a way that suits the differing policies of the various channel providers.

When an alert is received, an “alert mediator” (which could be a separate device or could be an application running on, for example, a set-top box) determines which channel is currently being played on a first user device (e.g., a television). The alert mediator reviews alert-rendering rules for that particular channel and prepares the alert according to those rendering rules. The alert is then presented either to that first user device or to a second user device (e.g., a companion device such as a smartphone or tablet computer).

Any type of alert can be presented including advertisements, personal messages, public-service messages, reminders, and social-networking updates. Some alerts can be interactive, responding to user actions.

Some of the rendering rules are set by the provider of the channel. Any type of rule can be implemented. For example, a rule can provide for “skinning” the alert (e.g., setting a display border around the alert or otherwise formatting the alert) so that the alert fits in with the “look and feel” of the channel. A rule can specify that the alert will be delivered to the user only after an advertisement is played or that no alerts can be shown during a specified blackout period. The rules can be even be tailored to the number of people thought to be watching the user devices.

Other rules can specify that a channel-change operation will be delayed until the alert is acknowledged by the user. In some cases, the presentation of the alert can be deferred by the user. When the user finally decides to have the alert presented, the alert can either maintain the formatting that was originally given to it when the alert was received, or the alert can be reformatted according to rules associated with the channel that the user is currently watching.

Some user devices can display more than one channel at the same time. In this case, the alert mediator chooses which channel's rules to apply in displaying the alert, the choice based on, for example, which channel seems to have the user's current attention (based on, perhaps, which channel is using more of the screen area, which channel is displayed closer to the center of the screen, or which channel has a prioritized audio setting) or which channel is more accommodating to alerts (e.g., has fewer blackout conditions).

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1;

FIG. 3 is a functional diagram of an alert mediator; and

FIGS. 4a, 4b, and 4c together form a flowchart of a method for preparing an alert.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

Pop-up alerts are delivered to users. Aspects of the present invention manage the delivery so that many potential problems associated with pop-up alerts are alleviated. These problems could arise because some alerts are asynchronous (i.e., their appearance cannot be predicted based on local events), and some alerts are not associated with the provider of the channel that the user is currently watching. Some specific problems addressed by the present invention include:
An alert that is not associated with the current channel may distract the viewer from the current channel content. Such alerts can lead the user away from the channel provider. For example, a videogram alert invites the user to select and play the videogram rather than to continue to watch the channel provider's content, including advertisements, and, in the channel provider's worst case, the user may choose to not return to the provider's channel after watching the videogram.
Channel providers are also concerned that the pop-up alert will detract from the viewing experience crafted by the provider. The content of the alert may be inconsistent with the mood or context of the channel content. For example, an adult-oriented alert would conflict with cartoon content, and an alert may cover up a screen-based interface on the channel, thus masking information that is, in the channel provider's opinion, critical to the viewer.
Pop-up alerts may also dilute revenue to the channel provider by pre-empting revenue opportunities (e.g., in clickable advertisements) that would otherwise have been presented to the user during the time when the user's attention is focused on processing the alert.

By addressing these and other potential problems with pop-up alerts, aspects of the present invention enable alerts that can be both ubiquitous (i.e., they can appear on any channel at any time) and flexible (i.e., they are adapted to suit the policies or requirements of a specific channel provider).

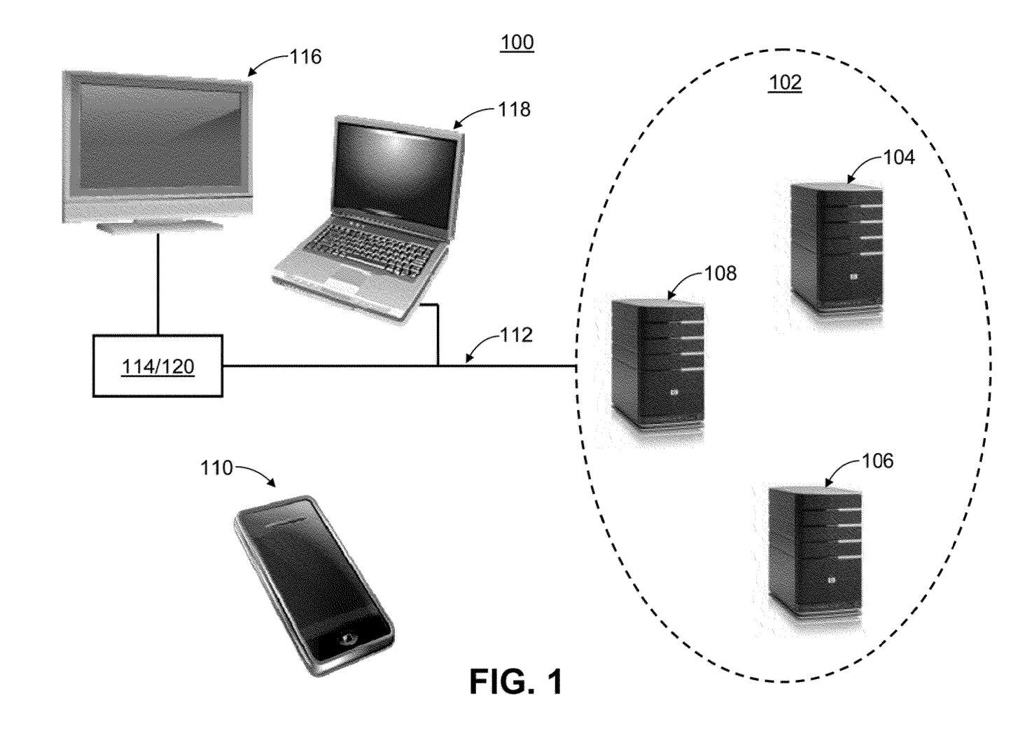

Aspects of the present invention may be practiced in the representative communications environment 100 of FIG. 1. Connected together via any or all of various known networking technologies 102 are servers such as channel providers 104, alert sources 106, and rule sources 108. For ease of illustration, only one of each type of server 104, 106, 108 is shown, but multiples of each can exist and can work together, as discussed below.

The servers 104, 106, 108 provide, via the networking technologies 102, media-download and alert services to end-user devices. One example of an end-user device is a cellular telephone 110. This telephone 110 communicates wirelessly to a wireless base station (not shown but known in the art) to access the public switched telephone network, the Internet, or other networks to access the services provided by the servers 104, 106, 108.

Non-wireless end-user devices are supported by “wireline” network technologies (e.g., fiber, wire, and cable) 112. For example, a set-top box 114 generally receives television programming from various channel providers 104 and provides a user interface (e.g., an interactive program guide) for selecting and viewing content from the cable provider. A digital video recorder (not shown) can store programming for later viewing. Video content may be viewed on a television monitor 116. In some situations, a laptop computer 118 accesses web-based services either wirelessly or via the wireline network 112. A home gateway, kiosk, digital sign, or media-restreaming device (not shown) are other possible end-user devices.

(A media-restreaming device transfers content between disparate types of networks. For example, it receives content from a cable system 112 and then transmits that content over a local radio link such as WiFi to the cellular telephone 110. The media-restreaming device usually operates in both directions to carry messages between the networks. In some embodiments, aspects of the present invention are practiced by a media-restreaming device.)

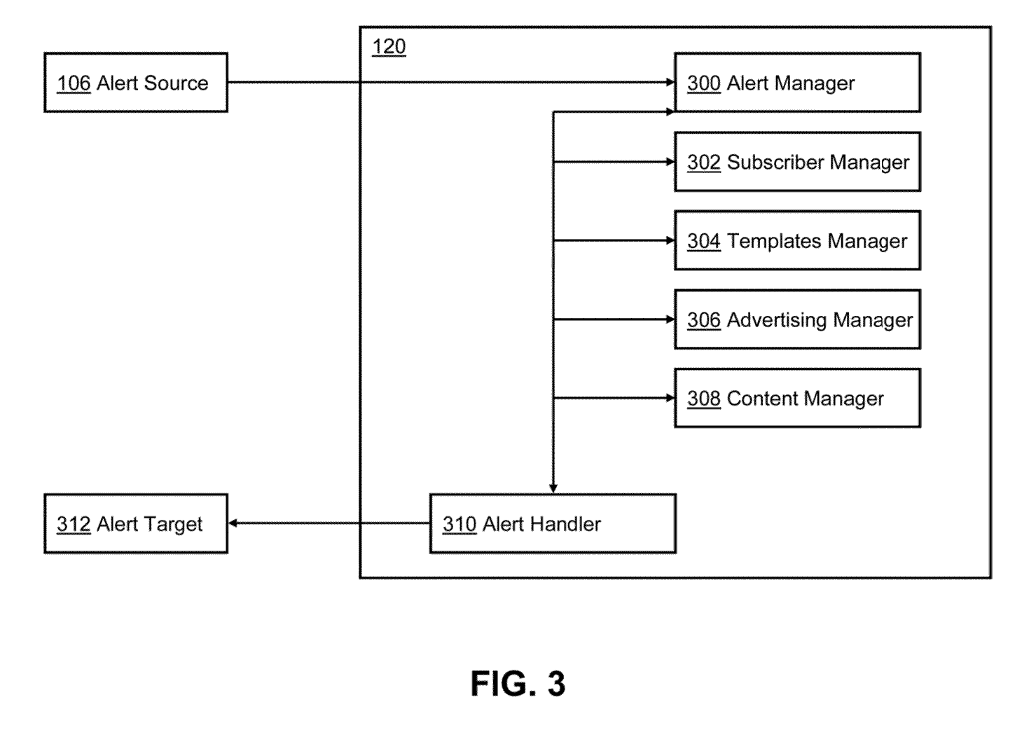

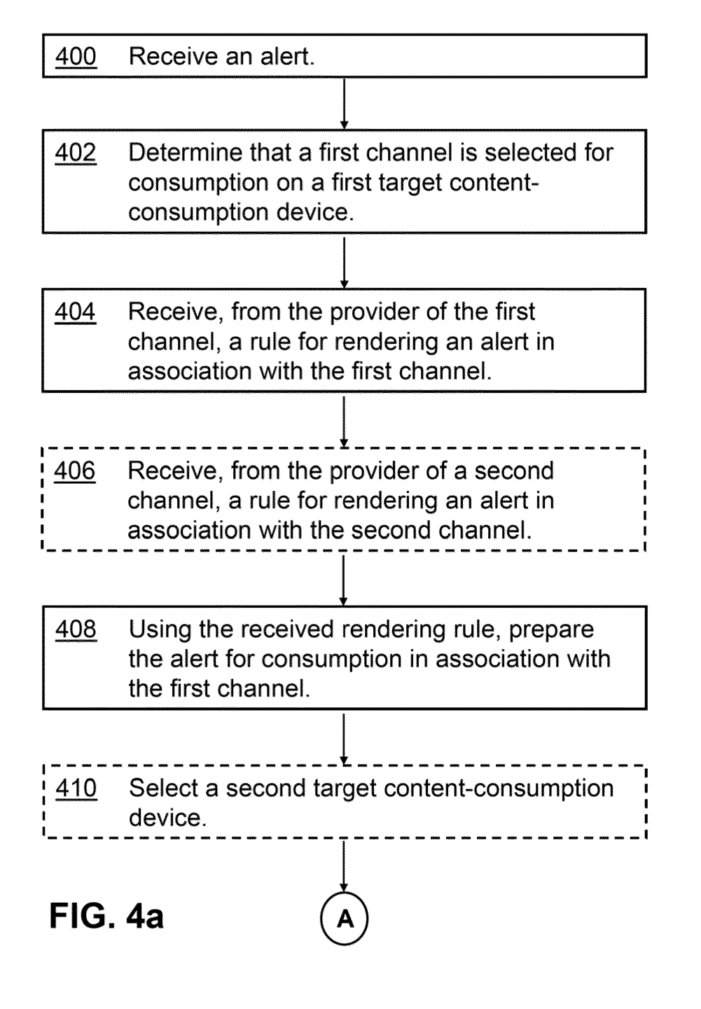

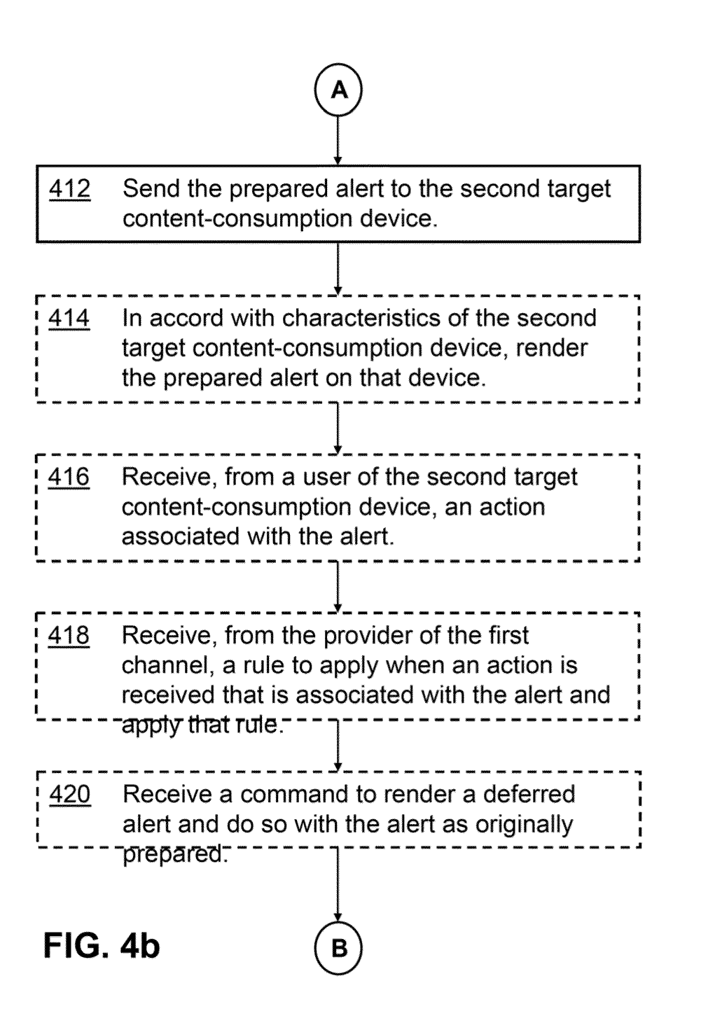

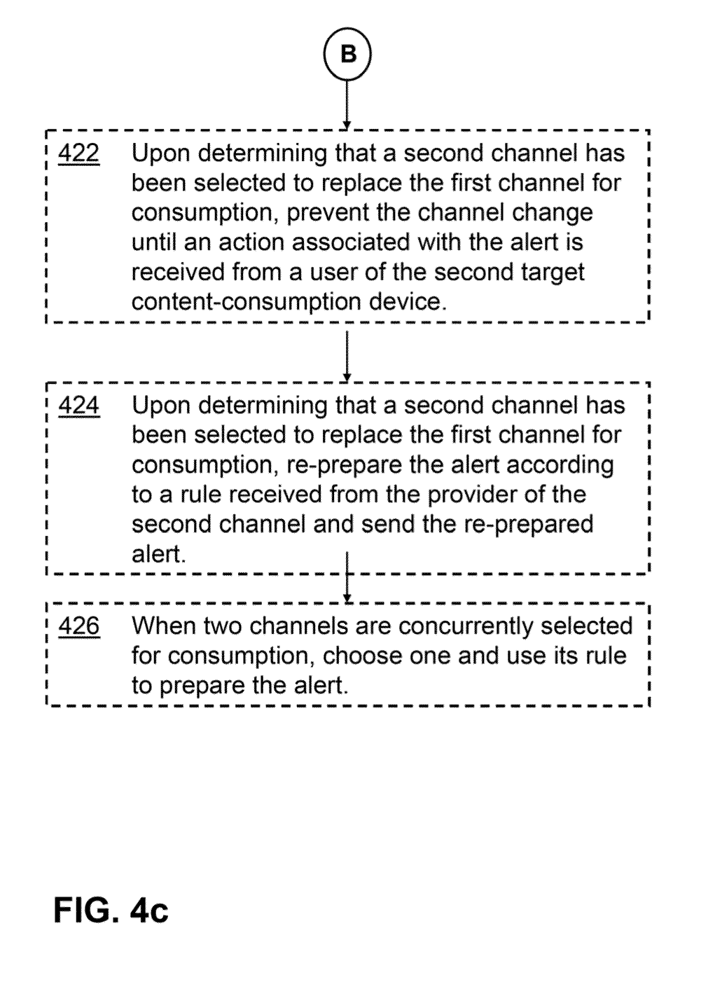

Of particular interest to the present discussion is the “alert mediator” function 120. In general, the alert mediator 120 receives an incoming alert, prepares the alert according to rules, delivers the alert to an appropriate device, and handles any interactions of a user with the alert. (Particular aspects of this function are discussed below in conjunction with FIGS. 3 and 4.) For the sake of simplicity, the present discussion assumes that the alert mediator function 120 is fully embodied on the set-top box 114, but in other embodiments the functions of the alert mediator 120 can reside within the head-end of a cable provider, on web servers, on an end-user device such as the cellular telephone 110, or on some combination of these.

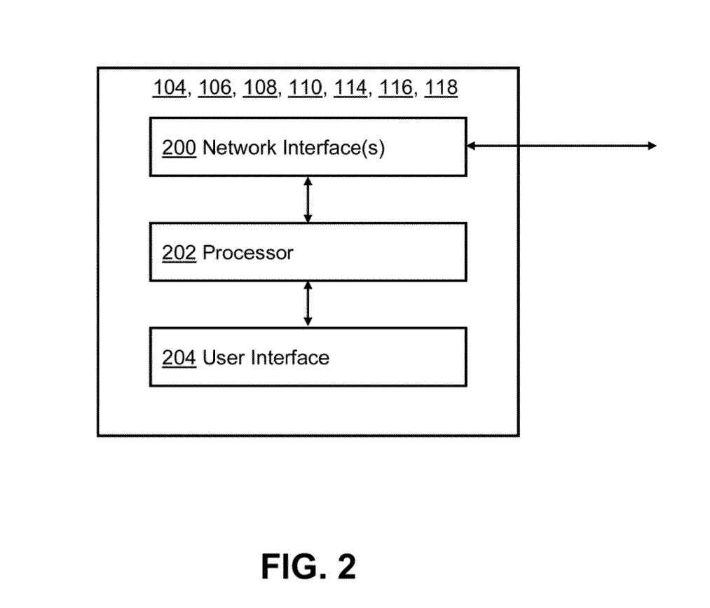

FIG. 2 shows the major components of a representative server 104, 106, 108 or end-user device 110, 114, 116, 118. Network interfaces 200 send and receive media presentations, related information, and download requests. A processor 202 controls the operations of the device and, in particular, supports aspects of the present invention as illustrated in FIGS. 3 and 4, discussed below. The user interface 204 supports a user's (or administrator's) interactions with the device. Specific uses of these components by specific devices are discussed as appropriate below.

FIG. 3 shows various components of an exemplary alert mediator function 120.

First, the alert source 106 can be any web-enabled, third-party application or service that generates and posts an alert to the alert mediator 120. Here, “alert” is meant to be very general: Alerts can be advertisements, calendar reminders, personal messages, public-service message, social-networking update, or service alerts, for example. The alert itself can be a descriptor (e.g., in XML) that provides such information as the intended recipient of the alert, alert text (e.g., a description of the alert), alert type (informative, interactive, or other), alert context (tags that describe a category for the alert), alert actions (potential interactions enabled in the alert), and alert elements (basic user-interface elements suggested by the alert source 106 for rendering this alert).

The alert manager 300 receives the alert and stores it (at least until the alert is discarded). Several alerts may be pending at one time within one alert mediator 120, so the alerts are probably each assigned a locally unique identifier and are queued for display.

The subscriber manager 302 manages details of “subscribers,” that is, potential recipients of the alerts that are directed to this alert mediator 120. These details can include email identifiers and device identifiers (e.g., an identifier of the recipient's cellular telephone 110). Thus, the subscriber manager 302 can read the intended recipient field of an alert descriptor and map it to a specific delivery (or “target”) device 312 to receive the alert.

The templates manager 304 receives templates and other rules from various rule sources 108. These rules may be authorized and authored by each channel provider 104. A rule can include contextual information showing when it should be applied such as a specific channel, a specific program, a specific time range, or a specific set of target-device profiles. These rules direct the alert mediator 120 in how to prepare the alert for presentation to the target device 312. The rules can define display themes set by the channel provider 104 so that the prepared alert matches the color, fonts, etc., for a channel or program or leverages richer visual or audio capabilities of a specific target device 312. Other possibilities are discussed below in conjunction with FIG. 4.

The advertising manager 306 maintains content (such as images, audio, or video) and mappings (to contextual cues such as keywords or a channel or program identifier) that are related to branding and advertising. This information can be pulled up by the alert handler 310 (see below) when it prepares the alert.

The content manager 308 manages retrieval and playback of content assets on a subscriber device (e.g., the television 116). Given a particular content reference request, the content manager 308 retrieves the associated asset and initiates streaming onto a specific channel to the requesting subscriber device. The alert handler 310 can use this channel reference to automate a channel change that allows a user to select any content associated with an alert as a follow-up action.

The alert handler 310 coordinates the activities of the other components of FIG. 3 in order to prepare the alert and to handle any user responses to the alert. It is discussed below in conjunction with FIG. 4.

Finally, the alert target 312 is typically a subscriber device (e.g., the set-top box 114, television 116, personal computer 118, gaming console, or cellular telephone 110) and is the destination of the prepared alert. If the target device 312 can run software applications, then it may also host some of the functionality of the alert mediator 120.

FIG. 4 presents an exemplary embodiment of the alert handler 310 of FIG. 3. Because the method of FIG. 4 includes so many options (as indicated by dashed boxes), to avoid confusion the present discussion first addresses only the “basic” elements (solid-line boxes). After that, the optional steps are discussed.

The method begins with step 400 of FIG. 4a where an alert is received from an alert source 106.

In step 402, the alert mediator 120 determines that a first channel has been selected for consumption on a “first target content-consumption device.” For example, the user has instructed the set-top box 114 to display broadcast television Channel 7 on the television 116. Numerous other types of channels are also possible including cable television channels, broadcast radio channels, private radio channels, satellite-provided channels, and Internet-provided channels. (Aspects of the present invention can apply where there is no clearly defined “channel.” Here, the role of the channel is filled by a playlist, webpage, or feed.) In some embodiments, the alert mediator 120 also determines which program is currently being shown on the selected channel.

In step 404, an “alert-rendering” rule (or other template) is received by the templates manager 304 for the selected Channel 7. When an alert comes in, the alert mediator 120 uses the selected channel information (and program information if available) to query the templates manager 304 for the appropriate “alert-rendering” rule to use with the received alert.

Note that step 404 need not, and most likely does not, occur after step 402. Rules and alerts are sent asynchronously, and the alert mediator 102 applies whatever rule it currently has (that is contextually appropriate) at the time when it needs to prepare the alert. In general, the steps of FIG. 4 need not occur in the order given.

Alert-rendering rules may be as simple or as complex as desired by the author of the rules. The rule could say “render the alert with the logo of the channel provider prominently displayed.” A rule could indicate that the alert be “skinned” in a particular way. For example, a border could be placed around the alert that makes the alert coordinate well with the content on the selected channel. Formats, fonts, colors, and the position of the alert can be specified.

Rules can specify exactly how and when the alert is to be rendered. The channel provider may specify the location of the alert in order to avoid covering critical portions of the channel content such as logos, crawlers, or on-screen interactive menus.

A blackout period can be set to prevent alerts from being displayed during particularly interesting portions of the channel offering (e.g., during very expensive advertising). (Urgent or health-related alerts may be able to override the general blackout rule.) Other rules can disable specific actions associated with an alert during the blackout period. For example, while the user may be able to view the alert, he cannot take an action that pulls him away from the current channel (although the alert can be deferred until after the blackout period at which time all actions associated with the alert are enabled). In another example, alerts with adult content would either be filtered or suppressed prior to 8 p.m.

Other rules can be more dynamic, specifying, for example, that an advertisement be played before (or after) the alert is presented, or that a particular sound or image be rendered along with the alert. A rule may limit the user's control during the presentation of the alert. For example, the user may be prevented from fast-forwarding through a pre- or post-alert advertisement. If more information is available to the alert mediator 120, then that information can be used in, say, rendering the alert in a fashion dependent upon the number of people currently estimated to be watching the target device 312.

Rules can specify what should happen at the end of the alert presentation. The user may be allowed to respond to the alert, defer the alert processing, or send the alert to another user. After that, the user is returned to the selected channel programming. In some embodiments, the alert mediator 120 can tell a digital video recorder (DVR) to record the content streaming on the selected channel. Then when the alert is dismissed, the content can be played back from the DVR so that the user does not miss any channel content. Also, if the selected channel was a Video on Demand program, then the headend of the channel provider can restart the playback where the user was before the alert.

Some of these rules are meant to be enforced strictly, while others may be “guidelines” to be applied only when contextually appropriate. When rendering an emergency alert, for example, the alert mediator 120 may choose to ignore most or all of the rules in order to make the alert as prominent and as visually arresting as possible.

In step 408, the alert handler 310 applies the rules as appropriate to this particular alert. As appropriate to the particular rule, the alert handler 310 may need to query the advertising manager 306 for content or content references with which to populate the template and to prepare the alert. The alert handler 310 also positions the alert and adds any active components to it (where the rule specifies these user-interface components). If a blackout applies, then the alert handler 310 may either defer the alert until a more appropriate time or may choose to override the blackout condition (e.g., for a time-critical warning).

In step 412 of FIG. 4b, the alert handler 310 sends the prepared alert to a “second” target content-consumption device 312. (As discussed above, the subscriber manager 302 knows which devices are associated with the intended recipient specified in the alert descriptor.) In many cases, the first and second target content-consumption devices are the same device. For example, the user is watching the television 116, and the alert is prepared and delivered to the television 116. In some cases, however, the alert handler 310 knows that the user is also watching a “companion device” such as the cellular telephone 110. The alert handler 310 may decide that it would be most appropriate to send the prepared alert to the companion device 110 instead of to the television 116.

This completes the discussion of the basic elements of FIG. 4. Returning to FIG. 4a, box 406 presents the first option. This emphasizes the fact that the alert mediator 120 receives different rules for different channels (and possibly for different programs or different times on the same channel). Different rules for different channels are further discussed below.

If more than one target content-consumption device is available, then the alert mediator 120 selects which such device should receive the rendered alert in step 410. This decision can be based on, for example, the capability of the device's screen for displaying the alert, the sensitivity of the alert (a private issue may be best sent to a companion device 110 rather than to the television screen 116), and whether or not the alert has interactive elements. In step 414, of FIG. 4b, the prepared alert may be specially formatted to match the capabilities of the alert target 312 (e.g., the resolution may be reduced for a small screen size). In some situations, the same alert can be formatted for and sent to more than one target content-consumption device. The alert itself or the rules can specify when this is appropriate (e.g., an urgent weather warning may be sent to all target content-consumption devices at the same time to increase the odds of its being read).

In step 416, the alert mediator 120 receives an action from the recipient of the alert and responds to that action. Exemplary actions include “save the alert,” “defer the alert,” “acknowledge the alert,” and “discard the alert.” The response may be determined by a special rule covering this case received by the alert mediator 120 in step 418. If the action is “defer the alert,” then in step 420 the alert is stored by the alert manager 300 and may be stored in its prepared format. The deferred alert may also be re-processed when it is later selected for viewing in order to enforce the rules of the context in which it is actually viewed.

It is possible that the user changes his channel selection while the alert is being displayed. In this case, there are at least two distinct possibilities. In step 422 of FIG. 4c, the channel-change command is delayed until the alert is acknowledged (or otherwise processed by the user).

Step 424 presents another possibility: The channel-change command is carried out, and the alert is re-prepared (steps 406 and 408) using the rules appropriate to the newly selected channel.

In step 426, the user has simultaneously selected more than one channel. The alert mediator 120 chooses one of the selected channels and uses the rules for that channel in preparing the alert. The choice can be for a channel placed “in front of” other channels, or for a channel that has been given more screen area than any other channel, or for a channel that is displayed nearest the center of the screen.

In view of the many possible embodiments to which the principles of the present invention may be applied, it should be recognized that the embodiments described herein with respect to the drawing figures are meant to be illustrative only and should not be taken as limiting the scope of the invention. For example, many other rules are contemplated that can work within the disclosed framework. Therefore, the invention as described herein contemplates all such embodiments as may come within the scope of the following claims and equivalents thereof.

We claim:

1. In a multi-channel communications environment, a method for preparing an alert in association with a channel, the method comprising:
receiving, by an alert mediator, the alert;
determining, by the alert mediator, that a first one of the channels is currently selected for consumption on a first target content-consumption device;
receiving, by the alert mediator from a first provider of the first channel, a rule for rendering an alert in association with the first channel;
preparing, by the alert mediator, the alert for consumption in association with the first channel, the preparing based, at least in part, on the rendering rule for the first channel; and
sending, by the alert mediator to a second target content-consumption device, the prepared alert.

2. The method of claim 1 wherein the alert is selected from the group consisting of: an advertisement, a reminder, a personal message, a public-service message, a social-networking update, and a service alert.

3. The method of claim 1 wherein the first and second target content-consumption devices are selected from the group consisting of: a set-top box, a television, a mobile telephone, a personal digital assistant, a personal computer, an electronic picture frame, a tablet computer, and a gaming console.

4. The method of claim 1 wherein the first and second target content-consumption devices are the same device.

5. The method of claim 1 wherein the first and second target content-consumption devices are distinct devices.

6. The method of claim 5 further comprising:
selecting one or more second target content-consumption devices.

7. The method of claim 1 wherein the alert mediator and the first target content-consumption device are the same device.

8. The method of claim 1 wherein the alert mediator and the first target content-consumption device are distinct devices.

9. The method of claim 1 wherein the first channel is selected from the group consisting of: a broadcast television channel, a cable television channel, a broadcast radio channel, a private radio channel, a satellite-provided channel, and an Internet-provided channel.

10. The method of claim 1 wherein the rendering rule is selected from the group consisting of: play an advertisement before rendering the alert, play an advertisement after rendering the alert, display a border around the alert, provide content for the border, specify a format for rendering the alert, position the alert over a specified portion of content delivered on the first channel, render the alert with a specified degree of transparency, do not render the alert in violation of a specified blackout condition, modify the alert in agreement with a specified blackout condition, play a video, render the alert in a modality matching that of content rendered on the first channel, display an image, play an audio alert, and render the alert based, at least in part, on an estimated number of people watching the second target content-consumption device.

11. The method of claim 1 further comprising:
rendering, by the second target content-consumption device, the prepared alert, the rendering based, at least in part, on a characteristic of the second target content-consumption device.

12. The method of claim 1 further comprising:
receiving, by the alert mediator from a second provider of a second channel, a rule for rendering an alert in association with the second channel;
wherein the second provider is distinct from the first provider; and
wherein the second channel is distinct from the first channel.

13. The method of claim 1 further comprising:
determining, by the alert mediator, that a second channel has been selected for consumption on the first target content-consumption device, the second channel selected to replace the first channel; and
preventing, by the alert mediator, the second channel from replacing the first channel until an action associated with the alert has been received from a user of the second target content-consumption device.

14. The method of claim 1 further comprising:
receiving, by the second target content-consumption device from a user of the second target content-consumption device, an action associated with the alert;
wherein the action is selected from the group consisting of: acknowledge the alert, save the alert, defer the alert, and delete the alert.

15. The method of claim 14 further comprising:
receiving, by the alert mediator from the first provider, a rule to apply when an action is received in association with an alert; and
applying the action rule.

16. The method of claim 14 wherein the received action is defer the alert, the method further comprising:
receiving, by the second target content-consumption device from the user of the second target content-consumption device, an instruction to render the deferred alert; and
rendering, on the second target content-consumption device, the deferred alert, the rendering based, at least in part, on the alert as originally prepared, by the alert mediator, for consumption in association with the first channel.

17. The method of claim 1 further comprising:
determining, by the alert mediator, that a second channel has been selected for consumption on the first target content-consumption device, the second channel selected to replace the first channel;
receiving, by the alert mediator from a second provider of the second channel, a rule for rendering an alert in association with the second channel;
re-preparing, by the alert mediator, the alert in association with the second channel, the re-preparing based, at least in part, on the rendering rule received for the second channel; and
sending, by the alert mediator to the second target content-consumption device, the re-prepared alert;
wherein the second channel is distinct from the first channel.

18. The method of claim 17 wherein the first and second providers are the same provider.

19. The method of claim 17 wherein the first and second providers are distinct providers.

20. The method of claim 1 further comprising:
determining, by the alert mediator, that a second one of the channels is also currently selected for consumption on the first target content-consumption device, wherein the second channel is distinct from the first channel; and
choosing, by the alert mediator, to prepare the alert in association with the first channel, wherein the choosing is based, at least in part, on an element selected from the group consisting of: which selected channel is rendered in front of the other, which selected channel is rendered nearer a center of a display screen, and which selected channel is rendered larger than the other.

21. An alert mediator configured for preparing an alert in association with a channel in a multi-channel communications environment, the alert mediator comprising:
a transceiver configured for receiving the alert and configured for receiving, from a first provider of a first one of the channels, a rule for rendering the alert in association with the first channel; and
a processor operatively connected to the transceiver and configured for:
determining that the first channel is currently selected for consumption on a first target content-consumption device;
preparing the alert for consumption in association with the first channel, the preparing based, at least in part, on the rendering rule for the first channel; and
sending, via the transceiver to a second target content-consumption device, the prepared alert.

22. The alert mediator of claim 21 wherein the alert mediator is selected from the group consisting of: a server, a plurality of servers, a set-top box, a television, a personal computer, and a gaming console.

23. The alert mediator of claim 21 wherein the alert mediator and the first target content-consumption device are the same device.

24. The alert mediator of claim 21 wherein the alert mediator and the first target content-consumption device are distinct devices.

25. The alert mediator of claim 21 wherein the processor is further configured for:
selecting the second target content-consumption device.

26. The alert mediator of claim 21:
wherein the transceiver is further configured for receiving, from a second provider of a second channel, a rule for rendering an alert in association with the second channel;
wherein the second provider is distinct from the first provider; and
wherein the second channel is distinct from the first channel.

27. The alert mediator of claim 21 wherein the processor is further configured for:
determining that a second channel has been selected for consumption on the first target content-consumption device, the second channel selected to replace the first channel; and
preventing the second channel from replacing the first channel until an action associated with the alert has been received from a user of the second target content-consumption device.

28. The alert mediator of claim 21:
wherein the transceiver is further configured for receiving, from a second provider of a second channel, a rule for rendering the alert in association with the second channel, wherein the second channel is distinct from the first channel; and
wherein the processor is further configured for:
determining that the second channel has been selected for consumption on the first target content-consumption device, the second channel selected to replace the first channel;
re-preparing the alert in association with the second channel, the re-preparing based, at least in part, on the rendering rule received for the second channel; and
sending, via the transceiver to the second target content-consumption device, the re-prepared alert.

29. The alert mediator of claim 21 wherein the processor is further configured for:
determining that a second one of the channels is also currently selected for consumption on the first target content-consumption device, wherein the second channel is distinct from the first channel; and
choosing to prepare the alert in association with the first channel, wherein the choosing is based, at least in part, on an element selected from the group consisting of: which selected channel is rendered in front of the other, which selected channel is rendered nearer a center of a display screen, and which selected channel is rendered larger than the other.
